(19) United States
(12) Patent Application Publication
(10) Pub. No.: US 2018/0318808 A1
(43) Pub. Date: Nov. 8, 2018

(54) METAL HYDROXIDE BASED IONIC LIQUID COMPOSITION

(71) Applicant: RELIANCE INDUSTRIES LIMITED, Mumbai, Maharashtra (IN)

(72) Inventors: Vibhuti DUKHANDE, Mumbai, Maharashtra (IN); Parasu Veera UPPARA, Navi Mumbai, Maharashtra (IN); Pavankumar ADURI, Dombivali, Maharashtra (IN); Vivek Prabhakar RAJE, Dist. Washim, Maharashtra (IN); Prathmesh Pradeep SALVI, Dist. Ratnagiri, Maharashtra (IN); Viswanath KOTRA, Hyderabad, Andhra Pradesh (IN); Mangesh SAKHALKAR, Navi Mumbai, Maharashtra (IN); Uday Meghashyam RATNAPARKHI, New Panvel (E), Maharashtra (IN)

(73) Assignee: RELIANCE INDUSTRIES LIMITED, Mumbai, Maharashtra (IN)

(21) Appl. No.: 15/772,206

(22) PCT Filed: Nov. 4, 2016
(86) PCT No.: PCT/IB2016/056645

§ 371 Date: Apr. 30, 2018

(30) Foreign Application Priority Data
Nov. 5, 2015 (IN) 4217/MUM/2015

(51) Int. Cl. B01J 27/10; B01J 35/12

(52) U.S. Cl. CPC B01J 27/10; B01J 2219/00047; B01J 35/12

(57) ABSTRACT

The present disclosure relates to an ionic liquid composition and a process for its preparation. The process of the present disclosure is simple, single pot and efficient process for preparing the ionic liquid composition which is effective in a Friedel Craft reaction like, alkylation reaction, trans-alkylation, and acylation.

The present disclosure envisages an ionic liquid composition comprising at least one metal hydroxide; at least one metal halide; and at least one solvent. Also envisaged is a process for preparing an ionic liquid composition. The process comprises mixing in a reaction vessel, at least one metal hydroxide and at least one metal halide in the presence of at least one solvent under a nitrogen atmosphere and continuous stirring followed by cooling under continuous stirring to obtain the ionic liquid composition.

### FIELD

The present disclosure relates to an ionic liquid composition and a process for its preparation.

### DEFINITIONS

As used in the present disclosure, the following terms are generally intended to have the meaning as set forth below, except to the extent that the context in which they are used indicate otherwise.

The expression ‘Clathrate’ for the purpose of the present disclosure refers to a chemical substance consisting of a lattice that traps or contains molecules.

The expression ‘Eutectic’ for the purpose of the present disclosure refers to a system that describes a homogeneous solid mix of atomic and/or chemical species, to form a joint super-lattice, by striking a unique atomic percentage ratio between the components; as each pure component has its own distinct bulk lattice arrangement.

### BACKGROUND

Ionic liquids are composed entirely of ions or a combination of cations and anions. The most common ionic liquids are those prepared from organic-based cations and inorganic or organic anions. The most common organic cations are ammonium cations, phosphonium and sulphonium cations. Ionic liquids of pyridinium and imidazolium are perhaps the most commonly used cations. Anions include, but are not limited to BF4⁻, PF6⁻, haloaluminates such as Al₂Cl₇⁻ and Al₂Br₇ ⁻, [(CF₃SO₂)₂N)]−, alkyl sulphates (RSO³⁻), carboxylates (RCO₂⁻) and many others. The most catalytically interesting ionic liquids are those derived from ammonium halides and Lewis acids (such as AlCl₃, TiCl₄, SnCl₄, FeCl₃ and the like). Chloroaluminate ionic liquids are perhaps the most commonly used ionic liquid catalyst systems. Ionic liquids may be suitable, for example, for use as catalysts and as solvents in alkylation and polymerization reactions as well as in dimerization, oligomerization acetylation, metatheses, and copolymerization reactions. Various methods have been mentioned for the preparation of ionic liquids. For example, ionic liquids can be prepared from organic cations and anions that can coordinate to the metal ions and by the addition of Lewis acid to Lewis base.

Further, “low temperature” ionic liquids are generally organic salts having melting point lower than 100 ° C., often even lower than room temperature. Further, some ionic liquids are fused salt compositions, which are molten at low temperature and are useful as catalysts, solvents, and electrolytes. Such compositions are mixtures of components which are liquids at temperatures below the individual melting points of the components.

The conventionally known “low temperature” ionic liquids are less effective when used as catalysts in the alkylation reactions. Further, these known ionic liquids are expensive. Still further, the acidity of the conventionally known ionic liquids are not tunable.

There is, therefore, felt a need for a cost-effective ionic liquid composition which can be effectively used in alkylation reaction.

### OBJECTS

Some of the objects of the present disclosure, which at least one embodiment herein satisfies, are as follows:

It is an object of the present disclosure to ameliorate one or more problems of the prior art or to at least provide a useful alternative.

An object of the present disclosure is to provide an ionic liquid composition that can be effectively used in alkylation, trans-alkylation, and acylation reactions.

Another object of the present disclosure is to provide a process for preparing an ionic liquid composition having a desired viscosity and density.

Other objects and advantages of the present disclosure will be more apparent from the following description, which is not intended to limit the scope of the present disclosure.

### SUMMARY

The present disclosure envisages an ionic liquid composition comprising at least one metal hydroxide; at least one metal halide; and at least one solvent. Typically, the metal hydroxide is present in an amount ranging from 3% to 40% by weight of the composition; the metal halide is present in an amount ranging from 8% to 90% by weight of the composition; and the solvent is present in an amount ranging from 10% to 70% by weight of the composition. Also envisaged is a process for preparing an ionic liquid composition. The process comprises mixing in a reaction vessel, at least one metal hydroxide and at least one metal halide in the presence of at least one solvent a under nitrogen atmosphere and continuous stirring to obtain a mixture. This mixture is then kept in a water bath at a temperature in the range of 80 to 120° C. under continuous stirring at 800 rpm for 4 hours to obtain a reaction mixture, followed by cooling the reaction mixture under continuous stirring at 800 rpm to obtain the ionic liquid composition in the form of an ionic liquid clathrate.

Typically, the solvent is selected from the group consisting of benzene, toluene, xylene, chlorobenzene, bromobenzene, substituted benzenes and ethylene dichloride. Typically, the metal of the metal hydroxide and the metal of at least one metal halide are same or are different. Typically, the metal of the metal hydroxide is selected from the group consisting of S-block metals, P-block metals and transition metals; wherein the metal of the metal hydroxide is selected from the group consisting of Al, Cr, Mn, Fe, Co, Ni, Cu, Zn, Ga, Ge, In, Sn, Ti, Pb, Cd, and Hg. Typically, the metal of the metal halide is selected from the group consisting of transition metals and P-block metals; wherein the metal of the at least one metal halide is selected from the group consisting of Al, Cr, Mn, Fe, Co, Ni, Cu, Zn, Ga, Ge, In, Sn, Ti, Pb, Cd, and Hg. Typically, the halide is selected from the group consisting of chloride, bromide, fluoride and iodide.

In an embodiment of the present disclosure, the ionic liquid composition has a viscosity ranging from 3 cP to 500 cP and density ranging from 1.00 to 2.50.

### DETAILED DESCRIPTION

Ionic liquids are entirely composed of ions. The so-called “low temperature” Ionic liquids are generally organic salts with melting point under 100 ° C., or even lower than room temperature. Such “low temperature ionic liquids” may be suitable as catalysts and as solvents in alkylation and polymerization reactions. The “low temperature ionic liquids” are also suitable in dimerization, oligomerization acetylation, metatheses, and copolymerization reactions. The conventionally known “low temperature” ionic liquid composition are less effective when used as catalysts in the alkylation reactions. Further, these known ionic liquid catalysts are expensive. Still further, the acidity of the conventionally known “low temperature” ionic liquids is not steady.

Therefore, the inventors of the present disclosure envisage an ionic liquid composition, and a process for preparing the ionic liquid composition that can be used in all Friedel Crafts reactions like, alkylation, reaction and that has a desired acidity.

In one aspect, the present disclosure envisages an ionic liquid composition.

The composition of the present disclosure, comprises at least one metal hydroxide, at least one metal halide, and at least one solvent.

In an embodiment of the present disclosure, the metal of the halides and the metal of the hydroxides are the same or different.

In yet another embodiment of the present disclosure, the solvent is at least one selected from the group consisting of benzene, toluene, xylene, chlorobenzene, substituted benzenes, and ethylene dichloride. Typically, the amount of solvent used in the ionic liquid composition is in the range of 10% to 70% by weight.

In an embodiment of the present disclosure, the metal of the metal halides is selected from the group consisting of transition metals and P-block metals. Typically, the metal of the metal halides, is at least one selected from the group consisting of Al, Cr, Mn, Fe, Co, Ni, Cu, Zn, Ga, Ge, In, Sn, Ti, Pb, Cd, and Hg. Typically the halide is at least one selected from the group consisting of chloride, bromide, fluoride and iodide.

In one embodiment of the present disclosure, the metal halide is at least one selected from the group consisting of AlCl₃, FeCl₃, GaCl₃, InCl₃, TiCl₄, SnCl₄, BiCl₃, and ZrCl₄.

In an embodiment of the present disclosure, the metal of the hydroxides is selected from the group consisting of S-block metals, P-block metals and transition metals. Typically, the metal of the metal hydroxides, is at least one selected from the group consisting of Al, Cr, Mn, Fe, Co, Ni, Cu, Zn, Ga, Ge, In, Sn, Ti, Pb, Cd, and Hg.

Typically, the amount of metal hydroxide used may be varied in order to obtain an ionic liquid of the desired acidity.

In one embodiment of the present disclosure, the metal hydroxide is at least one selected from the group consisting of Al(OH)₃, Fe(OH)₃, and Zn(OH)₂.

In an embodiment of the present disclosure, the ionic liquid composition comprises at least one metal hydroxide in an amount ranging from 3% to 40% by weight of the composition; at least one metal halide in an amount ranging from 8% to 90% by weight of the composition; and at least one solvent in an amount ranging from 10% to 70% by weight of the composition. Typically, the solvent is selected from the group consisting of benzene, toluene, xylene, chlorobenzene, bromobenzene, substituted benzenes and ethylene dichloride.

In another embodiment of the present disclosure, the viscosity of the ionic liquid composition ranges from 3 cP to 500 cP and density of the ionic liquid composition ranges from 1.00 to 2.50.

In yet another embodiment of the present disclosure, 1 mole of metal hydroxide reacts with 1 or more moles of metal halide in the presence of at least one aromatic solvent, under heating to form the ionic liquid composition.

Typically, the ionic liquid composition is formed by the same or different metals and the process may be applied to any metal hydroxide and to any metal halide.

In another aspect, the present disclosure envisages a process for the preparation of the ionic liquid composition. The process of the present disclosure is a single pot synthesis process; using at least one metal hydroxide, at least one metal halide, and at least one solvent.

The process of preparation of the ionic liquid composition comprises the step of mixing at least one metal hydroxide and at least one metal halide in at least one solvent under continuous stirring at a temperature in the range of 5 ° C. to 200 ° C. to obtain the ionic liquid composition. The ionic liquid composition of the present disclosure is in the form of ionic liquid clathrate.

The ionic liquid clathrate obtained from the process of the present disclosure is a metal hydroxide based clathrate. The clathrate is a chemical substance consisting of a lattice that traps or contains molecules of solvent in the metal hydroxide and metal halide ionic liquid.

In an exemplary embodiment 1 mole of aluminium hydroxide is heated with 1.5 moles AlCl₃ in the presence of benzene at 80 ° C. to obtain a eutectic mixture containing the ionic liquid composition.

The process of preparing a metal hydroxide based ionic liquid composition (ionic liquid clathrate) can be represented by the following general formulae—

M1+M2+M3+. . . +Mn+solvent=M1 •M2•M3•. . . •Mn•solvent (products)

Wherein, M1 is metal hydroxide, M2, M3, . . . , Mn are metal halides. M1, M2, M3, . . . , Mn contain metals which may be the same or different and n may range from 2 to 20. The dot (•) between M1, M2, M3, Mn and solvent represents at least one of co-ordinate covalent bonds and weak van der waal forces, and therefore the product forms an ionic liquid/eutectic mixture wherein the components are not ordinarily separable and take part in a reaction as a catalyst as a whole.

The present disclosure is further described in light of the following experiments which are set forth for illustration purpose only and not to be construed for limiting the scope of the disclosure. The following experiments can be scaled up to industrial/commercial scale and the results obtained can be extrapolated to industrial scale.

### EXPERIMENTS

### Experiment-1: Preparation of the Ionic Liquid Composition

100 ml of clean and dry three necked round bottom flask (RBF) was taken for the experiment. The center neck of the round bottom flask was used for overhead stirring using a glass stirrer, the other neck was mounted with a reflux condenser with nitrogen atmosphere, and the remaining neck was used for dispensing raw materials. The RBF was placed in a water bath at room temperature and the coolant flow was kept at 5 ° C. in the reflux condenser. 20 ml dry benzene was transferred into RBF by using a funnel and was stirred at 200 rpm. 2 g anhydrous Al(OH)₃ powder was added into the round bottom flask using an additional funnel. The addition was carried out under continuous stirring and maintained for 10 min at 300 rpm. 10.2 g AlCl₃ was added continuously into the round bottom flask by using an additional funnel in a batch of 2.50 g each. Stirring was continued for 5 min After stirring the reaction mixture for 5 min, the temperature of the water bath was increased to 80 ° C. The reaction mixture was stirred vigorously at 800 rpm for 4 hrs at 80 ° C., until no solids appeared in the RBF. Once the reaction mixture was dark brown in color, with no solid deposition in it, heating was stopped and stirring was continued at 800 rpm. The reaction mixture was cooled to 30 ° C. and the so obtained product was stored in air tight container, under N₂ atmosphere.

Similar experiments can be carried out and product can be obtained using metal hydroxides of Al, Cr, Mn, Fe, Co, Ni, Cu, Zn, Ga, Ge, In, Sn, Ti, Pb, Cd, and Hg, and metal halides of Al, Cr, Mn, Fe, Co, Ni, Cu, Zn, Ga, Ge, In, Sn, Ti, Pb, Cd, and Hg. Particularly, metal hydroxides are Al(OH)₃, Fe(OH)₃, and Zn(OH)₂. Further the solvents may be selected from the group consisting of benzene, toluene, xylene, chlorobenzene, bromobenzene, substituted benzenes and ethylene dichloride.

### Experiment-2: Alkylation Reaction

0.52 litre of hydrocarbon stream containing 10-13% C10-C14 olefins & 87-90% paraffins and 0.202 litre of benzene were charged into a 2.50 L glass reactor. The glass reactor was kept under an overhead stirrer in a heating mantle N₂ flow was ensured inside the reactor. The reactor was then heated to 38-39 ° C. Once this temperature was achieved, 7 g of the ionic liquid composition prepared as per experiment-1 was added (as a catalyst) to the reactor and stirred for 5 minutes. After 5 minutes the reaction mass was allowed to settle for 10 minutes. The upper hydrocarbon layer was then analyzed. The conversion of benzene into linear alkyl benzene was found to be 98%.

### TECHNICAL ADVANCEMENTS

The present disclosure described herein above has several technical advantages including, but not limited to, the realization of:
simple, single pot and efficient process for preparing an ionic liquid composition;
an ionic liquid composition which is effective in a Friedel Craft reaction like, alkylation reaction, trans-alkylation, and acylation;
an ionic liquid composition that has tunable acidity; and
an ionic liquid composition that has a desired viscosity and density.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the invention to achieve one or more of the desired objects or results. While certain embodiments of the inventions have been described, these embodiments have been presented by way of example only, and are not intended to limit the scope of the inventions. Variations or modifications to the formulation of this invention, within the scope of the invention, may occur to those skilled in the art upon reviewing the disclosure herein. Such variations or modifications are well within the spirit of this invention.

The numerical values given for various physical parameters, dimensions, and quantities are only approximate values and it is envisaged that the values higher than the numerical value assigned to the physical parameters, dimensions and quantities fall within the scope of the invention unless there is a statement in the specification to the contrary.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

1-7. (canceled)

8. An ionic liquid composition comprising:
at least one metal hydroxide;
at least one metal halide; and
at least one solvent;
wherein said solvent is selected from the group consisting of benzene, toluene, xylene, chlorobenzene, bromobenzene, substituted benzenes and ethylene dichloride.

9. An ionic liquid composition comprising:
at least one metal hydroxide in an amount ranging from 3% to 40% by weight of the composition;
at least one metal halide in an amount ranging from 8% to 90% by weight of the composition; and
at least one solvent in an amount ranging from 10% to 70% by weight of the composition;
wherein said solvent is selected from the group consisting of benzene, toluene, xylene, chlorobenzene, bromobenzene, substituted benzenes and ethylene dichloride.

10. The composition as claimed in claim 8, wherein the metal of said at least one metal hydroxide and the metal of said at least one metal halide are same or are different.

11. The composition as claimed in claim 9, wherein the metal of said at least one metal hydroxide and the metal of said at least one metal halide are same or are different.

12. The composition as claimed in claim 8, wherein the metal of said at least one metal hydroxide is selected from the group consisting of S-block metals, P-block metals and transition metals;
wherein the metal of said at least one metal hydroxide is selected from the group consisting of Al, Cr, Mn, Fe, Co, Ni, Cu, Zn, Ga, Ge, In, Sn, Ti, Pb, Cd, and Hg.

13. The composition as claimed in claim 9, wherein the metal of said at least one metal hydroxide is selected from the group consisting of S-block metals, P-block metals and transition metals;
wherein the metal of said at least one metal hydroxide is selected from the group consisting of Al, Cr, Mn, Fe, Co, Ni, Cu, Zn, Ga, Ge, In, Sn, Ti, Pb, Cd, and Hg.

14. The composition as claimed in claim 8, wherein the metal of said at least one metal halide is selected from the group consisting of transition metals and P-block metals;
wherein the metal of said at least one metal halide is selected from the group consisting of Al, Cr, Mn, Fe, Co, Ni, Cu, Zn, Ga, Ge, In, Sn, Ti, Pb, Cd, and Hg;
wherein said halide is selected from the group consisting of chloride, bromide, fluoride and iodide.

15. The composition as claimed in claim 9, wherein the metal of said at least one metal halide is selected from the group consisting of transition metals and P-block metals;
wherein the metal of said at least one metal halide is selected from the group consisting of Al, Cr, Mn, Fe, Co, Ni, Cu, Zn, Ga, Ge, In, Sn, Ti, Pb, Cd, and Hg;
wherein said halide is selected from the group consisting of chloride, bromide, fluoride and iodide.

16. The composition as claimed in claim 9, wherein said composition has a viscosity ranging from 3 cP to 500 cP and density ranging from 1.00 to 2.50.

17. A process for preparing an ionic liquid composition, said process comprising the following steps:
mixing in a reaction vessel, at least one metal hydroxide and at least one metal halide in the presence of at least one solvent a under nitrogen atmosphere and continuous stirring to obtain a mixture;
keeping said reaction vessel in a water bath at a temperature in the range of 80 to 120 ° C. under continuous stirring at 800 rpm for 4 hours to obtain a reaction mixture;
cooling said reaction mixture under continuous stirring at 800 rpm to obtain said ionic liquid composition in the form of an ionic liquid clathrate.
